(19) United States
(12) Patent Application Publication
(10) Pub. No.: US 2006/0019672 A1
(43) Pub. Date: Jan. 26, 2006

(54) Transmitting data in a wireless network

(75) Inventors: Troels Emil Kolding, Klarup (DK); Preben Mogensen, Gistrup (DK)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/174,616

(22) Filed: Jul. 6, 2005

(30) Foreign Application Priority Data
Jul. 7, 2004 (GB) GB 0415280.7

(51) Int. Cl. H04Q 7/20

(52) U.S. Cl. 455/452.2; 455/450

(57) ABSTRACT

A method is described for transmitting data, particularly but not exclusively packet data, from a transmitting station to a receiving station via a wireless channel. The data is transmitted in transmission intervals or TTI slots. The method comprises estimating a utilisation factor representing usage of the transmission intervals, and scheduling the data for transmission to increase the utilisation factor. The effect is to reduce stochastic pattern interference for other users in a wireless communications network. A network node for implementing the above method is also disclosed.

### FIELD OF THE INVENTION

This invention relates to transmitting data in a wireless communications network, and particularly but not exclusively to the transmission of data in the form of packets.

### BACKGROUND OF THE INVENTION

Packets can be transmitted according to the HSDPA (high speed downlink packet access) protocol implemented in a 3GPP wideband code division multiplex access (WCDMA) mobile telecommunications network.

High speed downlink packet access is a concept within WCDMA specifications whose main target is to increase user peak data rates and quality of service and to generally improve spectral efficiency for downlink asymmetrical and bursty packet data services. HSDPA introduces a short (2 millisecond) transmission time interval (TTI), adaptive modulation and coding (AMC), multicode transmission, fast physical layer (L1) hybrid automatic repeat request (H-ARQ) and uses a packet scheduler in a Node-B, where it has easy access to air interface measurements. HSDPA makes use of this by adjusting the user data rate to match the instantaneous radio channel conditions. While connected, an HSDPA user equipment periodically sends a channel quality indicator (CQI) to the Node-B indicating what data rate the user equipment can support under its current radio conditions. The user equipment sends an acknowledgement for each packet so that the Node-B knows when to initiate retransmissions. With channel quality measurements available for each user equipment in the cell, the packet scheduler may optimise its scheduling amongst its users and thus divide the available capacity between them according to the running services and requirements. Typically, the channel scheduler bases its selection on the highest available channel quality, waiting times of pending packets, or some combination hereof. Data is transmitted in bursts over transmission time intervals, occupied according to the scheduler algorithm.

In wireless cellular communication systems, the signal to interference and noise ratio (SINR) of the signal received by user equipment varies over time by as much as 30-40 dB due to fast fading and geographic location in a particular cell. In order to improve system capacity, peak data rate, and coverage reliability, the signal transmitted to a particular user is modified to account for the signal quality variations through a process referred to as link adaptation. Traditionally, WCDMA has used fast power control for link adaptation. However, HSDPA holds the transmission power constant over each TTI (a transmission time interval corresponding to three slots) and uses adaptive modulation and coding (AMC) as an alternative link adaptation method to power control in order to improve the spectral efficiency. The Node-B determines the transmission data rate based on CQI reports as well as power measurements on the associated channels (measurement of the user's dedicated channel power which can be used to predict also the performance on the HSDPA channel). The data rate is adjusted by modifying the modulation scheme, the effective code rate as well as the number of channelisation codes on the physical channel. Packet scheduling for HSDPA is located in the medium access layer MAC-hs of the 3GPP layer protocol. This layer is located in the Node-B, which means that the packet scheduling decisions are almost instantaneously executed. A popular packet scheduling method is the proportional fair packet scheduler. With this type of scheduler, users are served in an order determined by the highest instantaneous relative channel quality. That is, it attempts to track the fast fading behaviour of the radio channel. Since the selection is based on relative conditions, each user still gets approximately the same amount of allocation time, but the raise in system capacity easily exceeds 50%.

FIG. 1 is a schematic diagram which illustrates the problem which can arise with HSDPA in this context. FIG. 1 shows a cellular wireless communications network with a plurality of base stations or Node-Bs in UTRAN (Universal Telecom Radio Access Network) terminology. The Node-Bs will be referred to as base stations in the following.

A first base station 2 has an active radio link RL with user equipment UE in the form of a mobile station. The mobile station can be a mobile telephone or any other kind of mobile unit, for example a communicator or PC or any other device. The communications network also includes other base stations, two of which, 4, 6, are shown in FIG. 1. These base stations are transmitting signals to other user equipment in the network and cause interfering signals to be received at user equipment UE. The other base stations can communicate the same or other types of services as for base station 2. It is assumed that they include packet scheduling operation such that the transmission settings are altered over short time intervals. These interfering signals are labelled IS1, IS2 respectively. A particular problem arises with the interference at the user equipment UE in a situation where the base stations 2, 4, 6 support fast packet scheduling and link adaptation, for example, supporting the WCDMA/HSDPA standard (wide band code division multiplexed access/high speed downlink packet access). Recent packet service enhancements made to cellular standards facilitate opportunistic packet scheduling and link adaptation techniques in the downlink (DL) direction (from the base station 2 to the user equipment UE). According to the HSDPA concept, which is used as an illustrative example, the aim is to switch quickly between a number of users in a cell and to send large data rates to these users, mainly when they are experiencing good instantaneous radio channel conditions. Radio channel conditions are monitored at the user equipment UE in the form of the narrow band signal to interference and noise ratio (SINR). According to present technologies, packet scheduling and link adaptation techniques only work properly when the radio channel quality experienced at the UE is stable over a predetermined period, at the moment at least 10-20 milliseconds. The interfering signals, e.g. IS1 and IS2, are components in defining the overall radio channel quality. Hence, these need also be relatively stable over the 10-20 millisecond intervals for the link adaptation and packet scheduling methods to work.

Due to the statistical properties of packet data services and the availability of suitable radio channel conditions, there will be times when there is data to send and times when there is no data to send (even when the radio channel conditions are good). This is the basic nature of packet-based services and becomes more pronounced when the peak data rates on the channel are high. When a high quality of service (QoS) has been specified, channel utilisation is even less stable since it is necessary to make conservative choices about system resource allocation. The effect of this is that not all possible time slots are utilised. The effect of this is that transmission over the radio links follows a stochastic pattern. This means that any particular user equipment UE receives so-called other cell interference power which also follows a stochastic pattern. In FIG. 1, example patterns of interference power are shown tracking the interfering signal links IS1, IS2. The resulting signal to interference and noise ratio perceived at the user interface UE is shown in the dotted circle marked SINR in FIG. 1. For systems where significant power is allocated to the packet service bearers, the instantaneous power fluctuations may easily be as large as 2-5 dB (depending on dominant interferer ratio) measured at the user equipment UE. Though this value is less than normal fading variations, it is nevertheless important to note that these changes happen abruptly and potentially at a very fast rate (e.g. several times within a 2-6 millisecond interval).

The problem is exacerbated by the fact that seen from a particular user equipment UE location, transmission and scheduling conducted in different cells/sectors is generally asynchronous and uncoordinated. This has the effect that the signal to interference and noise ratio SINR may change by a large amount and with a very high variation speed (that is, several times within the scheduling or transmission time intervals TTI).

The problem can be partially alleviated by allocating suitable amounts of system resources to the base stations to increase the utilisation of time slots. However, this is a long term mechanism and cannot avoid fluctuations in the shorter term which happen because of the above mentioned quality of service aspects and the stochastic nature of packet traffic services. Further, there are permitted modes of operation where the base station is free to use all unused system resources, where the problem cannot be controlled by interaction methods at the radio network controller RNC. The resulting signal degradation that happens from these fluctuations due to uncoordinated TTI scheduling in different cells is potentially very damaging to system performance. The degradation happens at two different levels.

The user equipment detector performance (particularly channel estimation and decoding functionalities) is significantly impaired if there are large SINR variations within a TTI. This causes a loss in the single link capacity and calls for conservative link adaptation, which reduces spectral efficiency of the system.

Advanced packet scheduling and aggressive link adaptation techniques rely on stable conditions to achieve large cell capacity gains. Large SINR fluctuations per TTI prevent these techniques from working properly since there are delays involved in estimating the radio channel quality perceived at each user equipment. While we are here focusing on the HSDPA related link adaptation and packet scheduling, it should be noted that even fast power-controlled legacy bearers (such as dedicated channels used for e.g. control information and speech) may be significantly affected by these abrupt channel quality variations.

It is an aim of the present invention to control this type of othercell interference and to generally improve operating conditions in the network.

### SUMMARY OF THE INVENTION

According to one aspect of the invention there is provided a method of transmitting data from a transmitting station to a receiving station via a wireless channel, the data being transmitted in transmission intervals, the method comprising:

estimating a utilisation factor representing usage of the transmission intervals; and

scheduling the data for transmission to increase the utilisation factor.

In this context, the utilisation factor is defined as the ratio of scheduling slots (equal to TTIs for the HSDPA concept) that are used to transmit data Nᵤₛₑ and the total number of scheduling slots available Nₜₒₜ.

Another aspect of the invention provides a network node in a communications network for transmitting data to a receiving station via a wireless channel, the network node comprising:

means for receiving data to be transmitted;

means for transmitting data in transmission intervals;

means for estimating a utilisation factor representing usage of the transmission intervals; and

means for scheduling the data for transmission to increase the utilisation factor.

The following described embodiments of the invention illustrate a method which controls othercell interference in an intelligent way, which increases the spectral efficiency of the system while providing good operating conditions for the advanced scheduling and link adaptation techniques discussed earlier.

In the following described embodiment, othercell interference power is controlled in a multicell network by predicting a near term utilisation factor. The utilisation factor is taken into account when controlling scheduling of data across transmission intervals, for example transmission time intervals (TTIs).

The method can be implemented with a fast response time working at the required per TTI level. It can be adjusted by specifying a time interval over which the utilisation factor is measured. If this measuring interval is sufficiently small, no significant delays are introduced by the method. Increases in absolute delays which might be caused by implementing an algorithm to affect the method of the invention can be reduced to the order of 2-4 milliseconds, which is considered to be negligible compared to other inherent scheduling delays.

For a better understanding of the present invention and to show how the same may be carried into effect, reference will now be made by way of example to the accompanying drawings.

### BRIEF DESCRIPTION OF THE DRAWINGS

FIG. 1 is a schematic diagram of a cellular communications network showing the nature of interfering signals;

FIG. 2 is a schematic diagram showing the context of HSDPA;

FIG. 2A shows an example of signal based scheduling;

FIG. 3 shows HSDPA signalling channels;

FIG. 4 is a schematic block diagram of circuitry in a Node-B for implementing an embodiment of the invention;

FIG. 5A shows a sequence of transmission slots;

FIG. 5B shows nominal transmission power without using the present invention; and

FIG. 5C shows transmission power when applying a method in accordance with an embodiment of the invention.

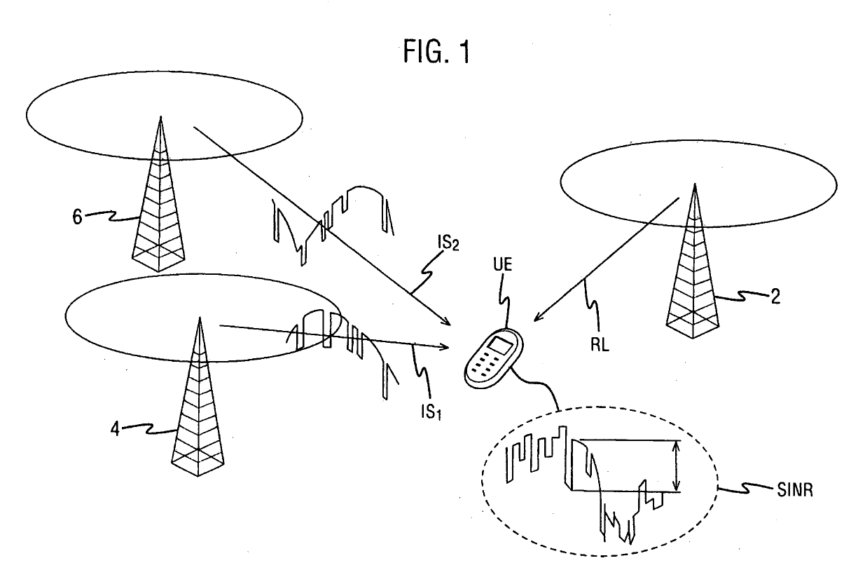

### DESCRIPTION OF THE PREFERRED EMBODIMENT

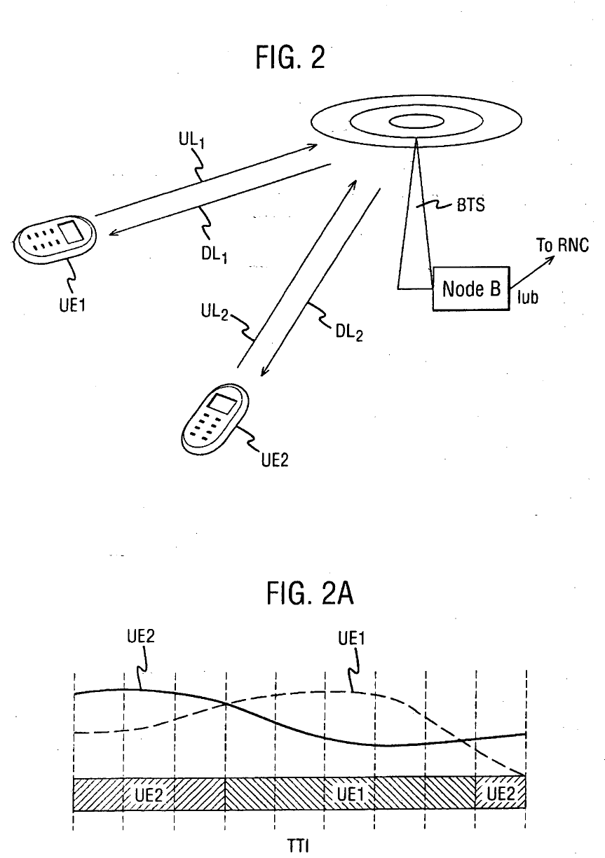

FIG. 2 illustrates the context of the following described embodiment of the invention. A base station BTS transmits packet based services to a plurality of users in its cell. Two users are shown, denoted UE1, UE2. Each user receives signalling and data along a respective downlink DL1, DL2, and returns channel quality feedback (for example Channel Quality Indicator (CQI), Ack/Nack, Transmission Power Control (TPC)) over a corresponding uplink channel, UL1, UL2 respectively. The base station incorporates a Node-B which communicates with the radio network controller RNC over the IUB interface. In general, transmissions are arranged in a way that two users scheduled within the same cell (same Node-B) will not interfere with each other provided that there is no multipath effects in the cell. The system described herein addresses interference which can arise when another user is scheduled by another Node-B.|

FIG. 2A shows one example of a very simple packet scheduler implementation of HSDPA packet scheduling to make maximum use of channel quality. FIG. 2A shows how the channel quality varies for the two user equipments UE1, UE2 with respect to time. It also shows along the horizontal axis how the packet-based service is scheduled for transmission to each of the user equipments, based on that channel quality. That is, when the channel quality for the second user equipment UE2 is better than the channel quality for the first user equipment UE1, packets are scheduled for transmission to the second user equipment UE2. When the situation changes, and the channel quality for the second user equipment UE2 is less than the channel quality for the first user equipment UE1, then packets are scheduled for transmission to the first user equipment UE.

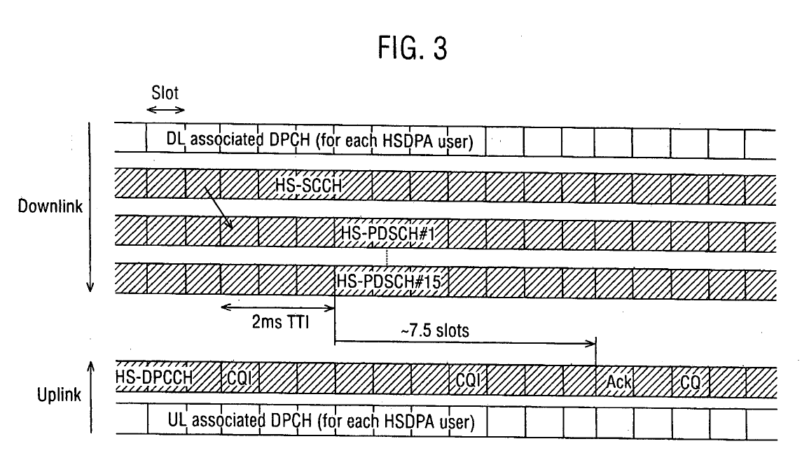

FIG. 3 illustrates channels used in implementing HSDPA. The HSDPA concept introduces a new transport channel, the high-speed downlink shared channel (HS-DSCH) to carry the user data. The corresponding physical channels are denoted by HS-PDSCH#1 to HS-PDSCH#15, one for each channelisation code. Within any given TTI, all or some channelisation codes may be distributed to a single user or divided between several users (code multiplexing).

The HS-DSCH code resources consist of one or more channelisation codes with a fixed spreading factor of 16. Up to 15 such codes can be allocated in order to leave sufficient room for other required control and data bearers. The available code resources are primarily shared in the time domain, e.g. they are allocated one user at a time. However, it is also possible to share the code resources using code multiplexing, in which case two to four users share the code resources within the same TTI.

The HS-DSCH employs a TTI of length 2 ms. This short TTI reduces link adaptation delays, increased the granularity in the scheduling process and facilitates better tracking of the time varying radio conditions.

Besides the user data, the base station must also transmit control signalling to notify the next user equipment to be scheduled. This signalling is conducted on a high-speed shared control channel (HS-SCCH) which is common to all users, and is done by transmitting the HS-SCCH TTI two slots in advance of the corresponding HS-DSCH TTI. The HS-SCCH is encoded by a user equipment-specific mask and also contains the lower layer control information, including the employed settings for modulation, coding scheme, channelisation code and H-ARQ.

Every user equipment has an associated low bit-rate dedicated physical channel (DPCH) in both the uplink and downlink directions. The downlink associated channel carries the signal radio bearer for layer 3 signalling as well as power control commands for the uplink channel, whereas the uplink is used as a feedback channel, carrying, for instance, the TCP acknowledgements. If needed, other services such as speech can be carried on the DCPH as well.

The HSDPA concept also introduces an additional high-speed dedicated physical control channel (HS-DPCCH) in the uplink for carrying CQI information as well as H-ARQ acknowledgements.

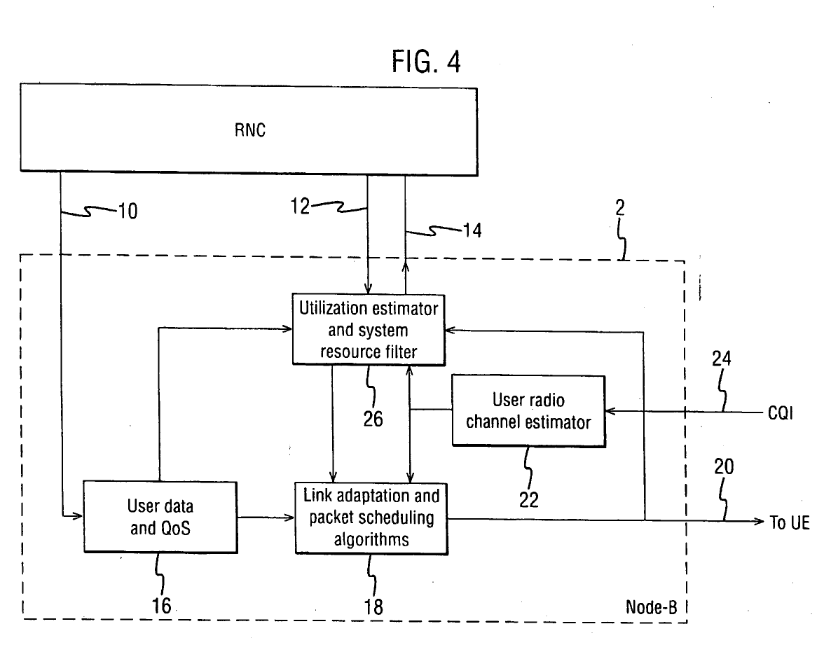

FIG. 4 is a schematic diagram of circuitry at a base station for implementing one embodiment of the invention. FIG. 4 also shows a radio network controller RNC connected to the base station 2. The radio network controller supplies user data to the base station 2 over a communication path 10 as well as user or service specific settings related to required quality of service (QoS). Also, in response to requests received from the base station 2 along communication path 14, it supplies resource allocation information in the form of, for example, power levels and codes for WCDMA channel selection along communication path 12.

The circuitry at the base station 2 includes a buffer 16 which receives the user data along communication path 10 along with QoS settings such as maximum delays, scheduling priorities, guaranteed throughputs or equivalent. An HSDPA unit 18 receives user data and QoS settings from the buffer block 16 and implements packet scheduling and link adaptation algorithms for transmitting packet data to the user equipment over downlink path 20. To aid the packet scheduling and link adaptation, the HSDPA unit 18 receives radio channel quality estimates from an estimator 22 which receives information from each user equipment on uplink path 24, such as CQI. In addition, the HSDPA unit 18 receives information about the allocated system resources from a utilisation estimator and system resource filter 26. The estimator and filter 26 receives resource allocation information from the radio network controller RNC. The estimator and filter 26 also receives data and QoS settings from the buffer 16, radio channel estimates from the estimator 22 and scheduling information for data which is transferred on the downlink path 20 from the HSDPA unit 18. It uses this information to perform two functions which assist with the evening out of power distribution for high speed packet transmission.|

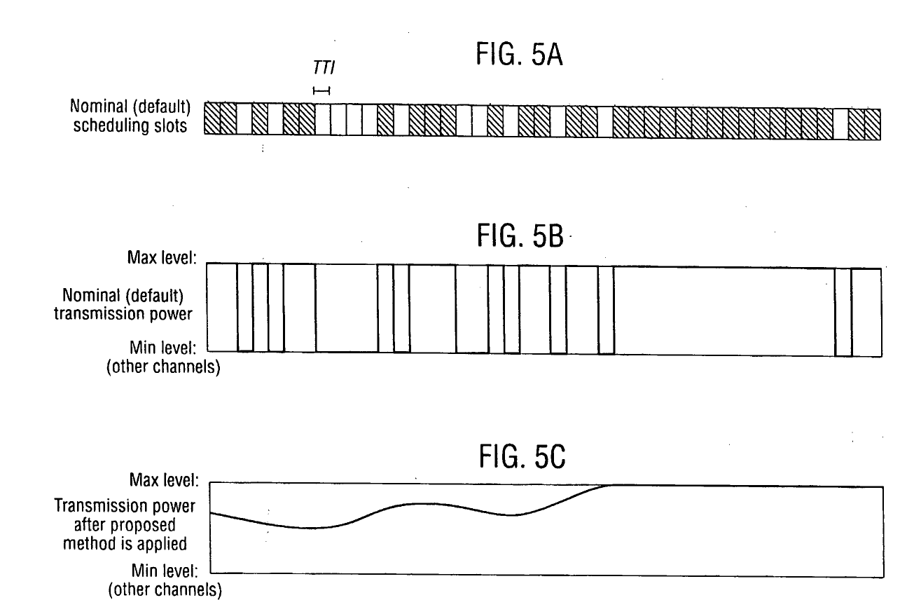

The first step is estimation of the near term utilisation factor. The purpose of this step is to estimate how many unused TTIs will occur in the near term (for example over the next 10-20 milliseconds). FIG. 5A illustrates a sequence of scheduling slots or TTIs, with shaded slots illustrating used TTIs and unshaded slots illustrating unused TTIs. If it is estimated that Nᵤₛₑ TTIs will be used compared to the total amount of TTIs (Nₜₒₜ), a utilisation factor of:
U=Nᵤₛₑ/Nₜₒₜ
can be defined. The utilisation factor can be estimated in a number of different ways, and some examples are given below.

1. Implementation as a simple averaging filter based on utilisation in the near term past (for example a low pass function to slow down transmission power variations on the data bearer).

2. A prediction based on user data buffer status as well as the currently estimated radio channel capacity for the users.

3. A prediction considering the quality of service settings, that is, a more conservative estimate should be made if it is known that delays cannot be tolerated for some users.

4. A prediction based on traffic behavioural patterns for the users, for example, prediction of arriving packets.

There are many other possible implementations, and in addition the above examples can be combined. For optimum results, the prediction algorithm should update its result each scheduling interval. For illustration purposes, a very simple implementation example could be (not considering code multiplexing and fractional power link adaptation/scheduling):

For each scheduling slot (equal to TTI for HSDPA):

Set X(TTI-1)=1 if HS-DSCH was transmitted in last scheduling
slot (TTI-1);
Otherwise, Set X(TTI-1)=0;
Estimate utilization factor U(TTI)=U(TTI-1)*(1−1/Navg) +
X(TTI-1)/Navg;

end

This example implementation uses a filter with an exponential “forgetting factor” controlled by the parameter Navg. Navg thus determines the speed and accuracy of the calculation and must be adjusted to facilitate efficient operation and proper QoS control (could be done adaptively determined on what user services are running etc.).

The second step is the adjustment or filtering of system resources, based on the near term utilisation factor. Once the utilisation factor has been estimated, it can be adjusted back to approximately 1 by adjusting the data rate that would normally be sent for each TTI by the utilisation factor. For example, if the estimated utilisation factor U is 0.5, the data rate per TTI is halved in order to increase the utilisation factor back to one. One way that this can be done is to lower the block error rate (BLER) target, which is the number of blocks per second with detectable errors. Another way, which is more spectrally efficient, is to adjust the transmission via the main system parameters, such as the transmission power. If the transmission power is lowered, the experienced radio channel quality at the UE is lower in the same way. This again, leads to a lowered available data rate for the user. For example, for a utilisation factor of 0.5, the available power per TTI could be halved, maintaining the same amount of codes, such that all TTIs would be sent with half power, compared to full power in every second TTI. In addition to this basic improvement, there is an additional spectral efficiency gain, since the power can be reduced even more, because it is more spectrally efficient to transmit lower data rates when the number of codes remains the same. That is, if the data rate is halved, the power can be ‘more than halved’. The Node-B is allowed to control its transmission power used for the HS-DSCH every TTI provided that it does not exceed the maximum allocation if such has been determined by the radio network controller.

FIG. 5B illustrates the default transmission power in the absence of application of a method in accordance with an embodiment of the invention. That is, for each used TTI, the maximum power level (of around 5 dB) is illustrated, and the significant and fast variations in power level can easily be seen from FIG. 5B.

FIG. 5C shows the effect of application of the above described method on the transmission power. That is, the resulting power level varies more slowly and thus does not disturb other cell scheduling and link adaptation to anything like the same extent as the power distribution of FIG. 5B.

In implementing the above described method, a more stable transmission power is achieved. In addition, power and code resource utilisation is improved such that the overall radio resource management (RRM) functions of the RNC become more accurate. Moreover, it is possible to improve spectral efficiency gain if the techniques are implemented properly for the same overall transmitted data rate (that is, if required power is reduced per system capacity).

It will be appreciated that there are a number of variations which fall within the scope of the present invention. For example, thresholds can be introduced for determining if and when action should be taken to override a default setting of always using the maximum system resources (transmission power). As another enhancement, in cases where it is not possible to take the utilisation factor close enough to one (due to insufficient data), it is possible to transmit dummy power (for example a dummy transmission sequence) in order to stabilise the interference to other cells. If the utilisation factor is almost one, the loss of doing this is minimal compared to the potential loss in link adaptation and packet scheduling performance without implementation of the method.

What is claimed is:

1. A method of transmitting data from a transmitting station to a receiving station via a wireless channel, the data being transmitted in transmission intervals, the method comprising:
estimating a utilisation factor representing usage of the transmission intervals; and
scheduling the data for transmission to increase the utilisation factor.

2. A method according to claim 1 wherein the step of scheduling the data comprises reducing a data rate for each transmission interval of the transmission intervals, thereby increasing a number of transmission intervals which are utilised.

3. A method according to claim 1 wherein the step of scheduling the data comprises reducing a power with which the data is transmitted in each transmission interval of the transmission intervals, and increasing a number of the transmission intervals in which the data is transmitted.

4. A method according to claim 1 wherein the step of estimating the utilisation factor comprises determining the utilisation factor for preceding transmission intervals.

5. A method according to claim 1 wherein the step of estimating the utilisation factor comprises examining a quantity of data to be transmitted with a signal quality of the wireless channel.

6. A method according to claim 5 wherein the step of estimating the utilisation factor further comprises inspecting quality of service requirements for the data.

7. A method according to claim 1 wherein the step of estimating the utilisation factor comprises predicting traffic at the receiving station.

8. A method according to claim 1, further comprising a step of setting threshold values for determining whether to reduce available system resources.

9. A method according to claim 1, wherein the step of scheduling the data comprises scheduling data to be transmitted in a form of packets.

10. A method according to claim 9, wherein the step of scheduling the data comprises scheduling packets to be transmitted according to a high speed packet data access (HSDPA) protocol.

11. A method according to claim 1, wherein the step of scheduling the data comprises scheduling the data to be encoded according to a wideband co-division multiplex access (WCDMA) system.

12. A method according to claim 1, wherein the step of scheduling takes into account a quality of the wireless channel.

13. A method according to claim 1, wherein the step of estimating takes into account a quality of the wireless channel.

14. A method according to claim 1, further comprising transmitting a dummy sequence, in an absence of insufficient data to increase the utilisation factor.

15. A network node in a communications network for transmitting data to a receiving station via a wireless channel, the network node comprising:
means for receiving data to be transmitted;
means for transmitting data in transmission intervals;
means for estimating a utilisation factor representing usage of the transmission intervals; and
means for scheduling the data for transmission to increase the utilisation factor.

16. A network node according to claim 15 wherein the means for receiving the data to be transmitted comprises a buffer.

17. A network node according to claim 15 wherein the means for receiving the data to be transmitted is configured to receive quality of service information for transmitting the data.

18. A network node according to claim 15 wherein the means for estimating the utilisation factor comprises means for establishing a ratio between a number of transmission intervals used for transmitting the data and a total number of available transmission intervals.

19. A network node according to claim 15 further comprising monitoring means for monitoring a signal quality of the wireless channel.

20. A network node according to claim 19 wherein the monitoring means are connected to the means for scheduling and configured to provide channel quality information for scheduling the data.

21. A network node according to claim 19 wherein the monitoring means are connected to the means for estimating and configured to provide channel quality information for estimating the utilisation factor.

22. A network node according to claim 15, wherein the network node comprises a Node-B.

23. A network node according to claim 15, wherein the network node comprises a base station.

24. A communication system including a terminal for connection in a network, the system including a network element for estimating a utilisation factor representing usage of transmission intervals for transmitting data from a transmitting station to a receiving station via a wireless channel and scheduling the data for transmission to increase the utilisation factor.

25. A computer program, embodied on a computer readable medium, comprising program instructions for causing a communications device to perform the method of:
estimating a utilisation factor representing usage of transmission intervals for transmitting data from a transmitting station to a receiving station via a wireless channel; and
scheduling the data for transmission to increase the utilisation factor.

26. A transmission entity, for transmitting data to a receiving station via a wireless channel, comprising:
means for estimating a utilisation factor representing usage of transmission intervals; and
means for scheduling the data for transmission to increase the utilisation factor.

27. A network node in a communications network for transmitting data to a receiving station via a wireless channel, the network node comprising:
a receiver, configured to receive data to be transmitted;
a transmitter, configured to transmit data in transmission intervals;
an estimator, configured to estimate a utilisation factor representing usage of the transmission intervals; and
a scheduler, configured to schedule the data for transmission to increase the utilisation factor.

28. A transmission entity, for transmitting data to a receiving station via a wireless channel, comprising:
an estimator, configured to estimate a utilisation factor representing usage of transmission intervals; and
a scheduler, configured to schedule the data for transmission to increase the utilisation factor.
